(19) United States
(12) Patent Application Publication
(10) Pub. No.: US 2005/0202915 A1
(43) Pub. Date: Sep. 15, 2005

(54) Method for reducing the noise of a sprocket chain as well as a sprocket chain

(75) Inventors: Michael Pichura, Buhl (DE); Markus Baumann, Karlsdorf-Neuthard (DE); Stephan Penner, Buhl (DE); Uwe Wagner, Buhl (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/028,160

(22) Filed: Jan. 3, 2005

Related U.S. Application Data
(63) Continuation of application No. PCT/DE03/02194, filed on Jul. 2, 2003.

(30) Foreign Application Priority Data
Jul. 4, 2002 (DE) 102 30 055.0

(51) Int. Cl. F16G 13/02

(52) U.S. Cl. 474/206; 474/215; 474/245; 474/214

(57) ABSTRACT

A chain including rocker arm pressure plates and links that are displaced in a staggered pattern next to each other in the longitudinal direction of the chain. The chain generates less noise than conventional chains when contacting the conical surfaces of conical disk pairs because of the configuration of the rocker arm pressure plates or the links.

The invention concerns a method for diminishing the noise arising during power transmission between a sprocket chain and a cone pulley pair of a cone pulley belt transmission. The invention furthermore concerns a sprocket chain for transmitting power between two cone pulley pairs of a cone pulley belt transmission.

Cone pulley belt transmissions with continuously variable transmission are increasingly being used for reasons of comfort and consumption. Even torques of over 300 Nm can be intermittently transmitted with such cone pulley belt transmissions, so that even middle and upper class vehicles are ouffitted with them. With the use in increasingly higher quality automobiles has become attached an increasing significance to acoustic comfort, that is especially a lesser development of noise by such cone pulley pair belt transmissions.

It is the object of the invention to improve the acoustic behavior of cone pulley belt transmissions.

A first approach at attaining the object of the invention is a method for reducing the noise arising during the power transmission between a sprocket chain and a cone pulley pair of a cone pulley belt drive, with said sprocket chain comprising a multitude of links with opening passages arranged in rows running side by side in the longitudinal direction of the belt and rocker arm pressure plates arranged transversely with respect to the sprocket chain, which project through the openings of the links and expose their front ends for a friction engagement with conical surfaces of the cone pulley pairs, wherein in said method the sprocket chain is configured in such a way that the time interval between the impact of successive front ends on the conical surfaces and/or the force of the impact is different if the rotational speed of the cone pulley pair is constant and the distance between cone pulleys is constant when the front ends of the rocker arm pressure plates make impact upon the conical surfaces of the cone pulleys of the cone pulley pair.

The regular impulse sequence produced by the uniform impact of the front ends of the rocker arm pressure plates on the conical surfaces is converted in accordance with the invention into a “dissonant” impulse sequence, which leads to smaller acoustical excitations and a correspondingly improved noise comfort.

A further approach at attaining the object of the invention is a sprocket chain for transmitting power between two cone pulley pairs of a cone pulley belt transmission, with said sprocket chain comprising a multitude of links with opening passages arranged in rows running side by side in the longitudinal direction of the belt and rocker arm pressure plates arranged transversely with respect to the sprocket chain, which project through the openings of the links and expose their front ends for a friction engagement with conical surfaces of the cone pulley pairs, with said sprocket chain having different distances between adjacent rocker arm pressure plates.

The length of the rocker arm pressure plates is advantageously variable.

A further sprocket chain for transmitting power between two cone pulley pairs of a cone pulley belt transmission, with said sprocket chain comprising a multitude of links with opening passages arranged in rows running side by side in the longitudinal direction of the belt and rocker arm pressure plates arranged transversely with respect to the sprocket chain, which project through the openings of the link and expose their front ends for a friction engagement with conical surfaces of the cone pulley pairs, while the rocker arm pressure plates are respectively arranged in pairs in such a way that the rocker arm pressure plates facing away from each other of two adjacent rocker arm pressure plate pairs rest at a spacing from each other on internal surfaces of at least one passage opening of a link, and the rocker arm pressure plates facing each other of the adjacent rocker arm power plate pairs penetrate passage openings of different links offset with respect to the link in the longitudinal direction of the sprocket chain (with which the objective of the invention is accomplished) and the rocker arm pressure plates of a rocker arm pressure plate pair have equal lengths, but the rocker arm pressure plates of different rocker arm pressure plate pairs have different lengths.

A modified embodiment of a sprocket chain for transmitting force between two cone pulley pairs of a cone pulley belt transmission, in which the sprocket chain comprises a multitude of links with opening passages arranged in rows running side by side in the longitudinal direction of the belt and rocker arm pressure plates arranged transversely with respect to the sprocket chain, which project through the openings of the links and expose their front ends for a friction engagement with conical surfaces of the cone pulley pairs, while the rocker arm pressure plates are respectively arranged in pairs in such a way that the rocker arm pressure plates facing away from each other of two adjacent rocker arm pressure plates rest at a spacing from each other on internal surfaces of at least one passage opening of a link, and the rocker arm pressure plates facing each other of adjacent rocker arm pressure plates penetrate into passage openings of different links arranged offset with respect to each other in the longitudinal direction of the sprocket chain in order to accomplish the objective of the invention, wherein the rocker arm pressure plates of a rocker arm pressure plate pair have different lengths.

The rocker arm pressure plates of each rocker arm pressure plate pair that come first into contact with the conical surfaces of a cone pulley pair are advantageously shorter.

A further modified embodiment of a sprocket chain for transmitting force between two cone pulley pairs of a cone pulley belt transmission, in which the sprocket chain comprises a multitude of links with opening passages arranged in rows running side by side in the longitudinal direction of the belt and rocker arm pressure plates arranged transversely with respect to the sprocket chain, which project through the openings of the links and expose their front ends for a friction engagement with conical surfaces of the cone pulley pairs, while the rocker arm pressure plate are respectively arranged in pairs in such a way that the rocker arm pressure plates facing away from each other of two adjacent rocker arm pressure plates rest at a spacing from each other on internal surfaces of at least one passage opening of one link, and the rocker arm pressures plate facing each other of adjacent rocker arm pressure plates penetrate into passage openings of different links arranged offset with respect to each other in the longitudinal direction of the sprocket chain in order to accomplish the object of the invention, wherein roller surfaces of the rocker arm pressure plates of different rocker arm pressure plate pairs that roll off each other are configured differently.

The distances of rocker arm pressure plate pairs adjacent to each other are advantageously different.

It is also advantageous that the distances between the rocker arm pressure plates and/or the lengths of rocker arm pressure plates are such that their alteration pattern is not repeated along the length of the sprocket chain.

To reduce manufacturing costs, a sprocket chain of the invention is designed preferably in such a way that there are rocker arm pressure plates with two different lengths, which are arranged in a predetermined pattern that is advantageously not repeated along the length of the sprocket chain.

The invention is suited for use in all types of sprocket chains in which the end surfaces of rocker arm pressure plates connected to each other by links in the longitudinal direction of the sprocket chain are provided with conical surfaces of cone pulley pairs for a friction engagement.

The invention is explained in further detail below with reference to schematic drawings, for example, wherein:

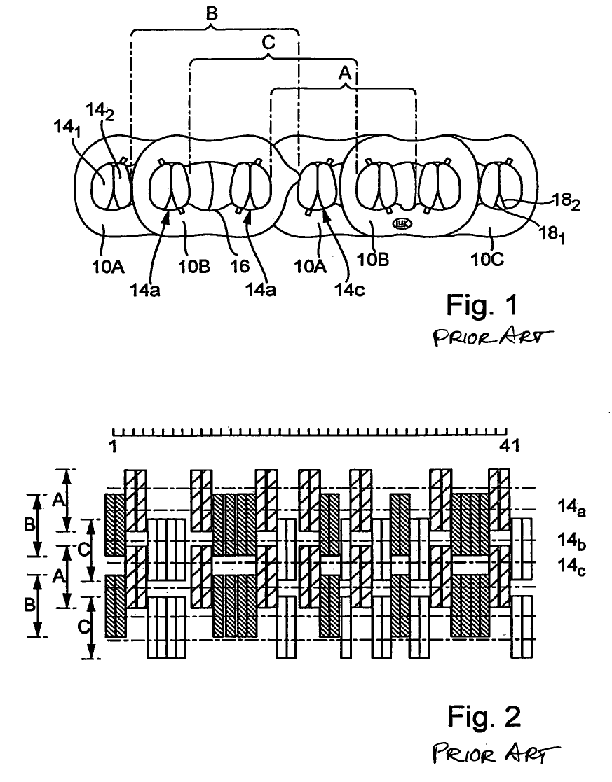

FIG. 1 shows a lateral view of a known sprocket chain,

FIG. 2 shows a schematic plan view on the sprocket chain of FIG. 1,

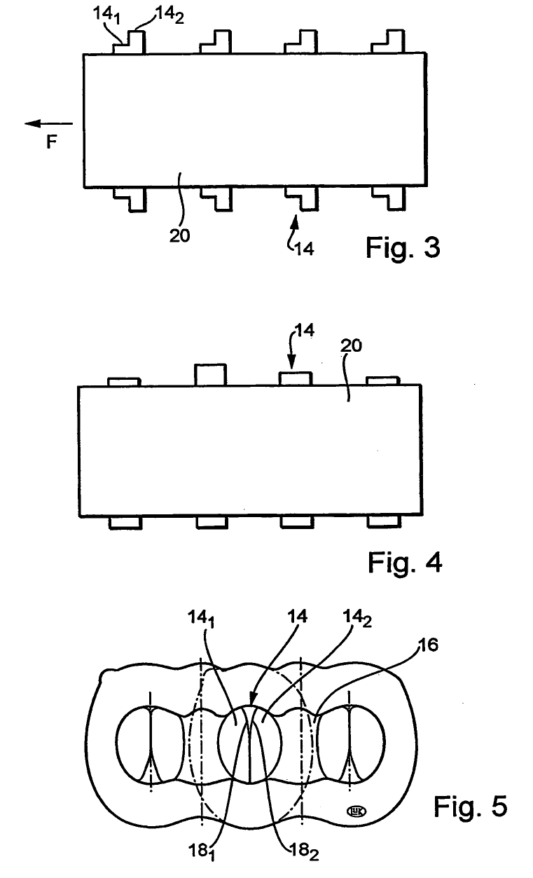

FIG. 3 shows a plan view on a section of a first embodiment of a sprocket chain of the invention,

FIG. 4 shows a plan view on a section of a second embodiment of a sprocket chain of the invention,

FIG. 5 shows a top view of a section of a third embodiment of a sprocket chain of the invention, and

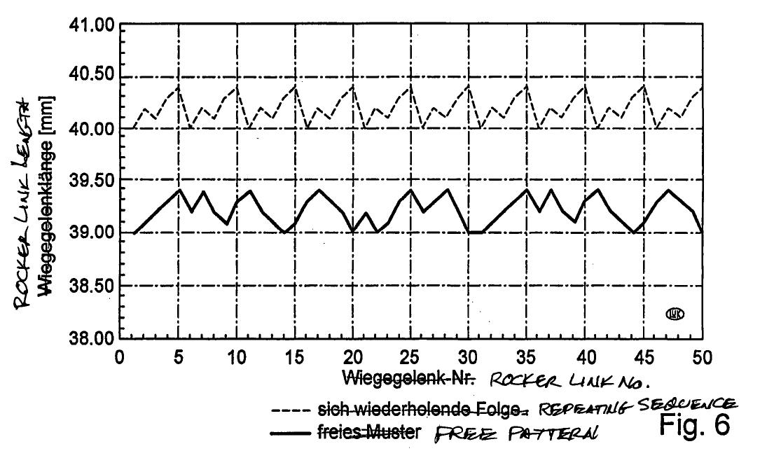

FIG. 6 shows examples of arrangement patterns of rocker arm pressure plates.

According to FIG. 1, a sprocket chain is composed of links 10 and rocker arm pressure plate pairs 14.

According to FIG. 2, the links 10 of a sprocket chain (41 overall) are arranged in rows running side by side with respect to each other in the longitudinal direction of the sprocket chain, wherein in the example that is shown, three different arrangement patterns A, B and C are present viewed transversely with respect to the sprocket chain, which are repeated in the longitudinal direction and are arranged offset with respect to each other in the longitudinal direction.

As can be seen in FIG. 2, a rocker arm pressure plate pair 14a respectively connects links 10A of group A and 10B of group B to each other, a succeeding rocker arm pressure plate 14b connects links 10B of group B and links 10C of Group C to each other; and a subsequent rocker arm pressure plate pair 14C connects links of group C and 10A of group A to each other. The arrangement is subsequently repeated. The rocker arm pressure plate pairs 14 penetrate into the longitudinal passage openings 16 respectively constructed in the links 10.

According to FIG. 1, the rocker arm pressure plates 14₁ and 14₂ of the rocker arm pressure plate pairs 14a and 14b facing away from each other are braced on the interior surfaces of the passage opening 16 spaced from each other, whereas the rocker arm pressure plates 14₁ and 14₂ of the rocker arm pressure plate pairs 14a and 14b facing each other take over the connection to the adjacent links 10A and 10C in the longitudinal direction of the sprocket chain with respect to the link 10B. The rocker arm pressure plates of each rocker arm pressure plate pair 14 are configured in such a way that their support surfaces 18₁ and 18₂ facing each other roll off each other when the sprocket chain circulates along a not represented cone pulley pair.

The design and the function of the described sprocket chain, which can be altered with respect to the arrangement of the links in the most varied of ways, is known and is therefore not explained in greater detail. The known sprocket chains are designed generally in such a way that all links and rocker arm pressure plate pairs are configured identical with respect to each other, especially the length of the rocker arm pressure plates is identical, so that their end surfaces that come to rest on the cone pulleys of a cone pulley pair circulate on the same radius if the distance between the cone pulleys of a cone pulley pair are not adjusted precisely with respect to the transmission adjustment of the transmission.

FIG. 3 schematically represents a first embodiment of a sprocket chain of the invention wherein the shaded region 20 represents the overall connection of the links from which the rocker arm pressure plate pairs 14 project laterally. In the example shown, the front rocker arm pressure plate in the direction of travel (arrow F) of the sprocket chain of a rocker arm pressure plate pair 14 is in each case configured shorter than the rear rocker arm pressure plate 14₂ in the direction of travel. The different length is represented in an exaggerated manner. The difference in length of the rocker arm pressure plates of a rocker arm pressure plate pair generally amounts to less than 1/10 mm and preferably is in the order of magnitude of 20 μm. With this different configuration, which can vary from rocker arm pressure plate pair to pressure plate pair, it is achieved that the rocker arm pressure plate 14₁ of each rocker arm pressure plate pair forming a link of the sprocket chain running into a cone pulley pair is braced on a somewhat smaller radius of the conic surface than the subsequent rocker arm pressure plate 14₂. The impact momentum arising when the end surface of the rocker arm pressure plate makes impact on the conical surfaces is mitigated in this way, whereby the acoustic behavior of the cone pulley belt transmission is improved.

The arrangement according to FIG. 3 can be improved in that the rocker arm pressure plate running off is shorter in any given case. Nonetheless, the embodiment represented is preferred.

The embodiment of the sprocket chain according to FIG. 4 differs from that of FIG. 3 in that the two not individually represented rocker arm pressure plates of each rocker arm pressure plate pair 14 are equally long, but the length of the rocker arm pressure plate pair 14 is different. The length of the rocker arm pressure plate pairs 14 varies overall around a maximum of approx. 0.6 mm and is preferably between 300 and 400 μm, while the difference between adjacent rocker arm pressure plate pairs is preferably smaller than the overall variation of the lengths of the rocker arm pressure plate pairs. With an arrangement according to FIG. 4, it is also ensured that the rocker arm pressure plate pairs circulate on different radii and that the acoustic behavior of a cone pulley belt transmission equipped with such a sprocket chain is improved, since an irregularity of impulses arises, which are generated when end faces impinge upon conic surfaces.

FIG. 5 shows a lateral view of a sprocket chain, which corresponds to FIG. 1. As can be seen, the rolling contact bearing surfaces 18₁ and 18₂ of adjacent rocker arm pressure plate pairs 14 that roll off each other are configured differently, so that the sprocket chain is not completely uniformly bent when running out on a cone pulley pair and an irregularity is attained upon running out.

A further possibility of calling forth irregularities when the sprocket chain runs out or generating impulses generated by placing the end surfaces of the rocker arm pressure plate on the conical surfaces consists in configuring the passage openings 16 of the links 10 with different axial lengths in such way that the distance between the rocker arm pressure plate pairs 14 is different in the longitudinal direction of the sprocket chain.

FIG. 6 shows two consequences of rocker arm joints or rocker arm pressure plate pairs 14 as they are arranged one after the other in the longitudinal direction and come to rest on the conical surfaces of the cone pulley pairs. The length of the rocker arm pressure plate pairs is indicated in mm in the vertical. The rocker arm pressure plate pairs arranged one after the other in the longitudinal direction of the sprocket chain are counted on the horizontal.

The pattern of the change in length is repeated respectively after five rocker arm joints in the upper curve of FIG. 6. There is no regular repetition of the length change pattern in the lower curve.

A total of five different rocker arm pressure plate lengths are used in the example of FIG. 6. It is understood that even merely two different rocker arm pressure plate lengths can be used and can be built up in different, irregular succession. The building up sequence is respectively oriented according to the requirements of the respective cone belt pulley transmission and of the motor vehicle in which the transmission is built up. The sequence can be theoretically optimized by means of simulations of the acoustic system. No disadvantages arise for the mechanical behavior of the transmission.

The various embodiments that are described can be combined with one each other. The temporal impulse sequence and/or strength of the impulse sequence varies overall, whereby the acoustic improvement is achieved. The variation can take place from the stochastic point of view or in a targeted manner in order to avoid any possible resonance. The effective length of a link and therewith of the running radius of the end surfaces of the rocker arm pressure plates is varied with the arrangement according to FIG. 5 (different rolling contact bearing surfaces or support angle of the rocker arm pressure plate of various rocker arm pressure plates).

It is understood that further variations are possible, such as for example different crownings of the end surfaces of the rocker arm pressure plates, et cetera. It is also understood that the invention can also be used for sprocket chains having a simplified design in which, for example, instead of rocker arm pressure plate pairs is used only merely one bolt or rocker arm pressure plate. However, such sprocket chains run with considerably higher internal friction.

The patent claims submitted with the application are formulation proposals without prejudice for attaining a continued patent protection. The applicant reserves the right to claim feature combinations previously disclosed only in the description and/or drawings.

The dependencies of the dependent claims point to the further configuration of the object of the main claim by the features of the respective dependent claim. They are not to be understood as a waiver of attaining an independent objective protection for the feature combinations of the dependent claims depending therefrom.

Since the objects of the dependent claims can form their own and independent inventions with respect to the state of the art on the priority day, the applicant reserves the right to make them into the object of independent claims or divisional applications. They can furthermore also contain independent inventions that have a configuration that is independent from the objects of the preceding claims.

The embodiments are not to be understood as a restriction of the invention. Rather, numerous alterations or modifications are possible within the scope of the current disclosure, especially such variants, elements and combinations and/or materials that can be deduced, for example, by the person skilled in the art by combining or modifying features or elements or method steps included in the general description and described in the embodiments as well as the claims and contained in the drawings with a view to attaining the object, and which lead to a new object or new method steps or step sequences by means of combinable features to the extent that they affect manufacturing, testing and operating methods.

1. A method for reducing the noise arising when transmitting power between a sprocket chain and a cone pulley pair of a cone pulley belt transmission, said sprocket chain comprising a multitude of links with opening passages arranged in rows running side by side in the longitudinal direction of the belt and rocker arm pressure plates arranged transversely with respect to the sprocket chain, which project through the openings of the link and expose their front ends for a friction engagement with conical surfaces of the cone pulley pairs, wherein the sprocket chain is configured in such a way that the time interval between the impact of successive front ends on the conical surfaces and/or the force of the impact is variable at a constant rotational speed of the cone pulley pair and constant distance between cone pulleys, if the front ends of the rocker arm pressure plates make impact on the conical surfaces of the cone pulleys of the cone pulley pair.

2. A sprocket chain for transmitting power between two cone pulley pairs of a cone pulley belt transmission, said sprocket chain comprising a multitude of links with opening passages arranged in rows running side by side in the longitudinal direction of the belt and rocker arm pressure plates arranged transversely with respect to the sprocket chain, which project through the openings of the link and expose their front ends for a friction engagement with conical surfaces of the cone pulley pairs, wherein the distance between adjacent rocker arm pressure plates is different.

3. The sprocket chain of claim 2, wherein the length of the rocker arm pressure plates is different.

4. A sprocket chain for transmitting power between two cone pulley pairs of a cone pulley belt transmission, said sprocket chain comprising a multitude of links with opening passages arranged in rows running side by side in the longitudinal direction of the belt and rocker arm pressure plates arranged transversely with respect to the sprocket chain, which project through the openings of the link and expose their front ends for a friction engagement with conical surfaces of the cone pulley pairs, while the rocker arm pressure plates are respectively arranged in pairs in such a way that the rocker arm pressure plates facing away from each other of two adjacent rocker arm pressure plate pairs are at a spacing from each other on internal surfaces of at least one passage opening of a link, and the rocker arm pressure plates facing each other of the adjacent rocker arm power plate pairs penetrate passage openings of different links offset with respect to the link in the longitudinal direction of the sprocket chain, wherein the rocker arm pressure plates of a rocker arm pressure plate pair have equal lengths, but the rocker arm pressure plates of different rocker arm pressure plate pairs have different lengths.

5. A sprocket chain for transmitting power between two cone pulley pairs of a cone pulley belt transmission, said sprocket chain comprising a multitude links with opening passages arranged in rows running side by side in the longitudinal direction of the belt and rocker arm pressure plates arranged transversely with respect to the sprocket chain, which project through the openings of the link and expose their front ends for a friction engagement with conical surfaces of the cone pulley pairs, while the rocker arm pressure plate are respectively arranged in pairs in such a way that the rocker arm pressure plates facing away from one each other of two adjacent rocker arm pressure plates are on internal surfaces spaced from one each other of at least one passage opening of a link, and the rocker arm pressure plates facing each other of adjacent rocker arm pressure plates penetrate passage openings of different links arranged offset with respect to each other in the longitudinal direction of the sprocket chain, wherein the rocker arm pressure plates of a rocker arm pressure plate pair have different lengths.

6. The sprocket chain of claim 5, wherein the rocker arm pressure plates of each rocker arm pressure plate pairs first coming into contact with the conical surfaces of a cone pulley pair are shorter.

7. A sprocket chain for transmitting power between two cone pulley pairs of a cone pulley belt transmission, said sprocket chain comprising a multitude of links with opening passages arranged in rows running side by side in the longitudinal direction of the belt and rocker arm pressure plates arranged transversely with respect to the sprocket chain, which project through the openings of the link and expose their front ends for a friction engagement with conical surfaces of the cone pulley pairs, wherein the rocker arm pressure plates are respectively arranged in pairs in such a way such that the rocker arm pressure plates facing away from each other of two adjacent rocker arm pressure plates are on internal surfaces of at least one passage opening of a link at a spacing to each other and the rocker arm pressure plates facing each other of adjacent rocker arm pressure plates penetrate passage openings of different links arranged offset with respect to each other in the longitudinal direction of the sprocket chain, wherein the roller surfaces of the rocker arm pressure plates of different rocker arm pressure plate pairs rolling off each other are configured differently.

8. The sprocket chain of claim 4, wherein the distances of adjacent rocker arm pressure plate pairs are different.

9. The sprocket chain of claim 2, wherein the distances between rocker arm pressure plates and/or lengths of rocker arm pressure plates are different, in such a way such that their changes are not repeated along the length of the sprocket chain.

10. The sprocket chain of claim 2, wherein rocker arm pressure plates with two different lengths are present.

11. The sprocket chain of claim 5, wherein the distances of adjacent rocker arm pressure plate pairs are different.

12. The sprocket chain of claim 7, wherein the distances of adjacent rocker arm pressure plate pairs are different.

13. The sprocket chain of claim 4, wherein the distances between rocker arm pressure plates and/or lengths of rocker arm pressure plates are different, in such a way such that their changes are not repeated along the length of the sprocket chain.

14. The sprocket chain of claim 5, wherein the distances between rocker arm pressure plates and/or lengths of rocker arm pressure plates are different, in such a way such that their changes are not repeated along the length of the sprocket chain.

15. The sprocket chain of claim 7, wherein the distances between rocker arm pressure plates and/or lengths of rocker arm pressure plates are different, in such a way such that their changes are not repeated along the length of the sprocket chain.

16. The sprocket chain of claim 4, wherein rocker arm pressure plates with two different lengths are present.

17. The sprocket chain of claim 5, wherein rocker arm pressure plates with two different lengths are present.

18. The sprocket chain of claim 7, wherein rocker arm pressure plates with two different lengths are present.
